(19) United States
(12) Patent Application Publication
(10) Pub. No.: US 2026/0368598 A1
(43) Pub. Date: Nov. 19, 2026

(54) FAULT-TOLERANT QUANTUM WALKS ON QUANTUM COMPUTERS

(71) Applicant: IonQ, Inc., College Park, MD (US)

(72) Inventor: Dominic WIDDOWS, Bellevue, WA (US)

(21) Appl. No.: 18/742,906

(22) Filed: Jun. 13, 2024

Related U.S. Application Data
(60) Provisional application No. 63/508,463, filed on Jun. 15, 2023.

(51) Int. Cl. G06N 10/60; G06N 10/20; G06N 10/70

(52) U.S. Cl. CPC G06N 10/60; G06N 10/20; G06N 10/70

(57) ABSTRACT

The techniques described herein relate to a quantum information processing (QIP) system and method for performing a quantum walk, including: generating a counter circuit that implements solely single-qubit rotations, wherein each respective qubit of a plurality of qubits in the arc counter circuit is rotated through an angle that is inversely proportional to a significance of the respective qubit and wherein the respective qubit is twice as significant as a predecessor qubit; and executing the counter circuit using a quantum processor unit (QPU).

### CROSS-REFERENCE TO RELATED APPLICATIONS

This application claims the benefit of U.S. Provisional Application No. 63/508,463, filed Jun. 15, 2023, which is herein incorporated by reference.

### TECHNICAL FIELD

Aspects of the present disclosure relate generally to systems and methods for use in the implementation, operation, and/or use of quantum information processing (QIP) systems.

### BACKGROUND

Quantum walks are a well-established topic in quantum information theory. They are related to Markov chains and graph walks, and proposed for modeling stock option prices. The standard presentation of a quantum walk combines a “coin operator” (a toss of a coin decides which direction to walk), and a “position operator” that stores, increments, and decrements the position of the particle whose movement is being simulated. Most implementations use the quantum adder pattern for incrementing and decrementing the position.

There are many entangling gates in a standard quantum adder, which makes these circuits too error-prone to be useful in practice, beyond a few steps. This is because of the way binary arithmetic works in terms of logical gates. To check if a bit should be “carried” in an addition operation, a check that all the previous bits are set to 1 needs to be performed. These checks have to be made at every time step, and the number of gates grows quadratically with the number of bits. As an example, to simulate a walk with just 8 steps with a position register of 4 qubits, requires almost 200 Toffoli gates, and thus several hundred 2-qubit gates. Even the current 2-qubit gate fidelities (in the high 99's range) are not enough for this task (e.g., 99.8%¹⁰⁰⁰≅13.5% accuracy).

### SUMMARY

The following presents a simplified summary of one or more aspects to provide a basic understanding of such aspects. This summary is not an extensive overview of all contemplated aspects and is intended to neither identify key or critical elements of all aspects nor delineate the scope of any or all aspects. Its sole purpose is to present some concepts of one or more aspects in a simplified form as a prelude to the more detailed description that is presented later.

The present disclosure outlines a few immediate alternative implementations of a quantum walk circuit. By relaxing the requirement that a walk proceed by exactly one unit at each time-step, the disclosed system produces circuits that do a more reliable job of simulating the expected cumulative effect of many steps.

In an exemplary aspect, the techniques described herein relate to a method for performing a quantum walk, including: generating a counter circuit that implements solely single-qubit rotations, wherein each respective qubit of a plurality of qubits in the arc counter circuit is rotated through an angle that is inversely proportional to a significance of the respective qubit and wherein the respective qubit is twice as significant as a predecessor qubit; and executing the counter circuit using a quantum processor unit (QPU).

In some aspects, the techniques described herein relate to a method, wherein each qubit of the plurality of qubits represents a digit in a binary register.

In some aspects, the techniques described herein relate to a method, wherein the counter circuit includes four qubits in the plurality of qubits.

In some aspects, the techniques described herein relate to a method, wherein each of the four qubits is rotated by five rotation gates.

In some aspects, the techniques described herein relate to a method, wherein a rotation gate associated with a first qubit performs a rotation along an x-axis by π/2 radians, a rotation gate associated with a second qubit performs a rotation along an x-axis by π/4 radians, a rotation gate associated with a third qubit performs a rotation along an x-axis by π/8 radians, a rotation gate associated with a fourth qubit performs a rotation along an x-axis by π/16 radians.

In some aspects, the techniques described herein relate to a method, wherein the arc counter circuit further includes a plurality of Hadamard gates, wherein at each step, a Hadamard gate of the plurality of Hadamard gates is used to determine whether a controlled rotation is performed on each other qubit of the plurality of qubits.

In some aspects, the techniques described herein relate to a method, wherein the controlled rotation is performed when the Hadamard gate outputs |1 [symbol] .

In some aspects, the techniques described herein relate to a method, wherein the counter circuit further includes a circuit component that performs Boolean disjunction.

In some aspects, the techniques described herein relate to a method, wherein the circuit component includes a logical conjunction AND operator that changes a state of an ancilla qubit of the counter circuit |0 [symbol] to |1 [symbol] only when all lower and higher order qubits have state |1 [symbol] .

In some aspects, the techniques described herein relate to a quantum information processing (QIP) system including: at least one memory; and at least one hardware processor coupled with the at least one memory and configured, individually or in combination, to: generate a counter circuit that implements solely single-qubit rotations, wherein each respective qubit of a plurality of qubits in the arc counter circuit is rotated through an angle that is inversely proportional to a significance of the respective qubit and wherein the respective qubit is twice as significant as a predecessor qubit; and execute the counter circuit.

In some aspects, the techniques described herein relate to a QIP system, wherein each qubit of the plurality of qubits represents a digit in a binary register.

In some aspects, the techniques described herein relate to a QIP system, wherein the counter circuit includes four qubits in the plurality of qubits.

In some aspects, the techniques described herein relate to a QIP system, wherein each of the four qubits is rotated by five rotation gates.

In some aspects, the techniques described herein relate to a QIP system, wherein a rotation gate associated with a first qubit performs a rotation along an x-axis by π/2 radians, a rotation gate associated with a second qubit performs a rotation along an x-axis by π/4 radians, a rotation gate associated with a third qubit performs a rotation along an x-axis by π/8 radians, a rotation gate associated with a fourth qubit performs a rotation along an x-axis by π/16 radians.

In some aspects, the techniques described herein relate to a QIP system, wherein the arc counter circuit further includes a plurality of Hadamard gates, wherein at each step, a Hadamard gate of the plurality of Hadamard gates is used to determine whether a controlled rotation is performed on each other qubit of the plurality of qubits.

In some aspects, the techniques described herein relate to a QIP system, wherein the controlled rotation is performed when the Hadamard gate outputs |1 [symbol] .

In some aspects, the techniques described herein relate to a QIP system, wherein the counter circuit further includes a circuit component that performs Boolean disjunction.

In some aspects, the techniques described herein relate to a QIP system, wherein the circuit component includes a logical conjunction AND operator that changes a state of an ancilla qubit of the counter circuit |0 [symbol] to |1 [symbol] only when all lower and higher order qubits have state |1 [symbol] .

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

The disclosed aspects will hereinafter be described in conjunction with the appended drawings, provided to illustrate and not to limit the disclosed aspects, wherein like designations denote like elements, and in which:

FIG. 1 illustrates a view of atomic ions a linear crystal or chain in accordance with aspects of this disclosure.

FIG. 2 illustrates an example of a quantum information processing (QIP) system in accordance with aspects of this disclosure.

FIG. 3 illustrates an example of a computer device in accordance with aspects of this disclosure.

FIG. 4 illustrates an example of an arc counter circuit.

FIG. 5 illustrates sample results from a quantum walk with an 8 qubit register.

FIG. 6 illustrates sample results for “up” and “down” circuits configured with different clock speeds.

FIG. 7 illustrates an example of an arc walk counter circuit.

FIG. 8 illustrates example results for the arc walk counter circuit

FIG. 9 illustrates an example of a random jump circuit.

FIG. 10 illustrates example results of a random jump circuit.

FIG. 11 illustrates an example of a cascading disjunction circuit.

FIG. 12 illustrates sample results when implementing a cascading disjunction circuit.

FIG. 13 illustrates a table of average distances traveled after n steps in an ideal simulation.

FIG. 14 illustrates a table of average distances traveled after n steps in a noisy simulation.

FIG. 15 illustrates a graph comparing ideal and actual QPU results for binary counter and arc walk circuits.

### DETAILED DESCRIPTION

The detailed description set forth below in connection with the appended drawings or figures is intended as a description of various configurations or implementations and is not intended to represent the only configurations or implementations in which the concepts described herein may be practiced. The detailed description includes specific details for the purpose of providing a thorough understanding of various concepts. However, it will be apparent to those skilled in the art that these concepts may be practiced without these specific details or with variations of these specific details. In some instances, well known components are shown in block diagram form, while some blocks may be representative of one or more well-known components.

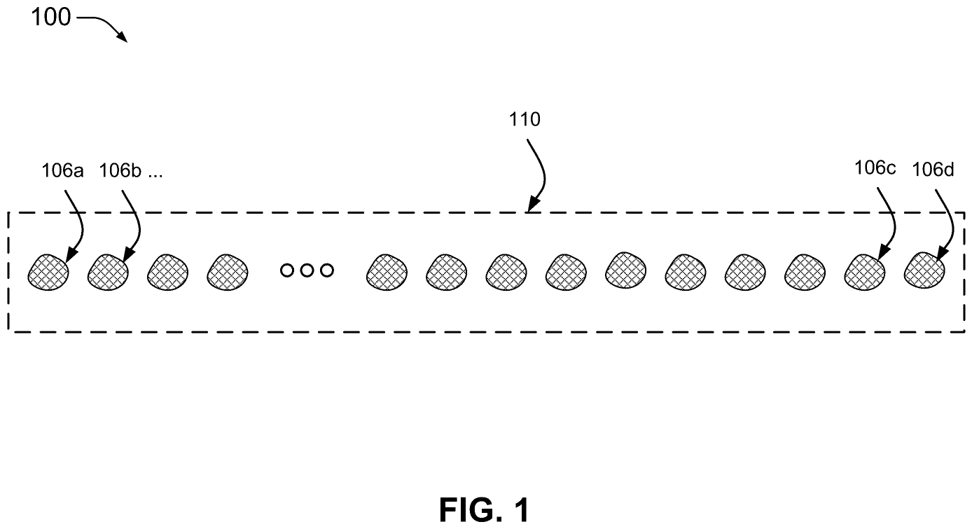

Solutions to the issues described above are explained in more detail in connection with FIGS. 1-12, with FIGS. 1-3 providing a background of QIP systems or quantum computers, and more specifically, of atomic-based QIP systems or quantum computers.

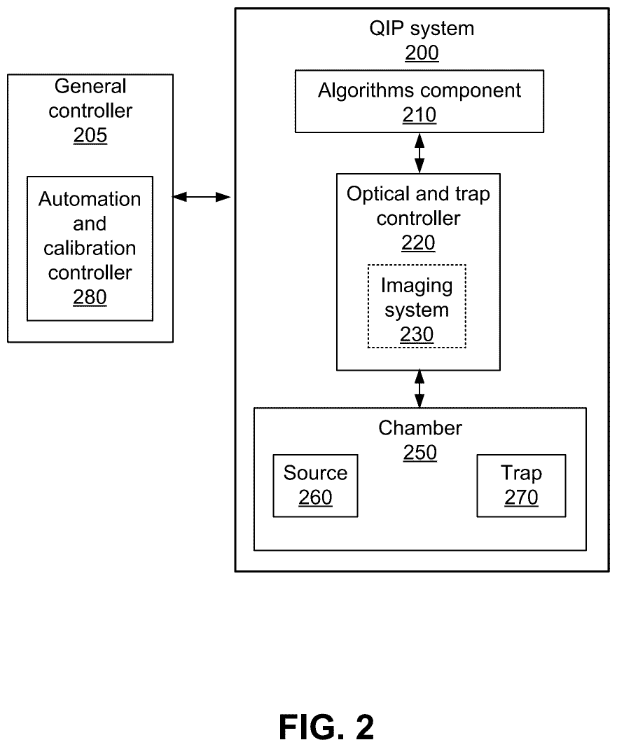

FIG. 1 illustrates a diagram 100 with multiple atomic ions or ions 106 (e.g., ions 106a, 106b, . . . , 106c, and 106d) trapped in a linear crystal or chain 110 using a trap (not shown; the trap can be inside a vacuum chamber as shown in FIG. 2). The trap maybe referred to as an ion trap. The ion trap shown may be built or fabricated on a semiconductor substrate, a dielectric substrate, or a glass die or wafer (also referred to as a glass substrate). The ions 106 may be provided to the trap as atomic species for ionization and confinement into the chain 110. Some or all of the ions 106 may be configured to operate as qubits in a QIP system.

In the example shown in FIG. 1, the trap includes electrodes for trapping or confining multiple ions into the chain 110 laser-cooled to be nearly at rest. The number of ions trapped can be configurable and more or fewer ions may be trapped. The ions can be Ytterbium ions (e.g., ¹⁷¹Yb⁺ ions), for example. The ions are illuminated with laser (optical) radiation tuned to a resonance in ¹⁷¹Yb⁺ and the fluorescence of the ions is imaged onto a camera or some other type of detection device (e.g., photomultiplier tube or PMT). In this example, ions may be separated by a few microns (μm) from each other, although the separation may vary based on architectural configuration. The separation of the ions is determined by a balance between the external confinement force and Coulomb repulsion and does not need to be uniform. Moreover, in addition to Ytterbium ions, neutral atoms, Rydberg atoms, or other types of atomic-based qubit technologies may also be used. Moreover, ions of the same species, ions of different species, and/or different isotopes of ions may be used. The trap may be a linear RF Paul trap, but other types of confinement devices may also be used, including optical confinements. Thus, a confinement device may be based on different techniques and may hold ions, neutral atoms, or Rydberg atoms, for example, with an ion trap being one example of such a confinement device. The ion trap may be a surface trap, for example.

FIG. 2 illustrates a block diagram that shows an example of a QIP system 200. The QIP system 200 may also be referred to as a quantum computing system, a quantum computer, a computer device, a trapped ion system, or the like. The QIP system 200 may be part of a hybrid computing system in which the QIP system 200 is used to perform quantum computations and operations and the hybrid computing system also includes a classical computer to perform classical computations and operations. The quantum and classical computations and operations may interact in such a hybrid system.

Shown in FIG. 2 is a general controller 205 configured to perform various control operations of the QIP system 200. These control operations may be performed by an operator, may be automated, or a combination of both. Instructions for at least some of the control operations may be stored in memory (not shown) in the general controller 205 and may be updated over time through a communications interface (not shown). Although the general controller 205 is shown separate from the QIP system 200, the general controller 205 may be integrated with or be part of the QIP system 200. The general controller 205 may include an automation and calibration controller 280 configured to perform various calibration, testing, and automation operations associated with the QIP system 200. These calibration, testing, and automation operations may involve, for example, all or part of an algorithms component 210, all or part of an optical and trap controller 220 and/or all or part of a chamber 250.

The QIP system 200 may include the algorithms component 210 mentioned above, which may operate with other parts of the QIP system 200 to perform or implement quantum algorithms, quantum applications, or quantum operations. The algorithms component 210 may be used to perform or implement a stack or sequence of combinations of single qubit operations and/or multi-qubit operations (e.g., two-qubit operations) as well as extended quantum computations. The algorithms component 210 may also include software tools (e.g., compilers) that facility such performance or implementation. As such, the algorithms component 210 may provide, directly or indirectly, instructions to various components of the QIP system 200 (e.g., to the optical and trap controller 220) to enable the performance or implementation of the quantum algorithms, quantum applications, or quantum operations. The algorithms component 210 may receive information resulting from the performance or implementation of the quantum algorithms, quantum applications, or quantum operations and may process the information and/or transfer the information to another component of the QIP system 200 or to another device (e.g., an external device connected to the QIP system 200) for further processing.

The QIP system 200 may include the optical and trap controller 220 mentioned above, which controls various aspects of a trap 270 in the chamber 250, including the generation of signals to control the trap 270. The optical and trap controller 220 may also control the operation of lasers, optical systems, and optical components that are used to provide the optical beams that interact with the atoms or ions in the trap. Optical systems that include multiple components may be referred to as optical assemblies. The optical beams are used to set up the ions, to perform or implement quantum algorithms, quantum applications, or quantum operations with the ions, and to read results from the ions. Control of the operations of laser, optical systems, and optical components may include dynamically changing operational parameters and/or configurations, including controlling positioning using motorized mounts or holders. When used to confine or trap ions, the trap 270 may be referred to as an ion trap. The trap 270, however, may also be used to trap neutral atoms, Rydberg atoms, and other types of atomic-based qubits. The lasers, optical systems, and optical components can be at least partially located in the optical and trap controller 220, an imaging system 230, and/or in the chamber 250.

The QIP system 200 may include the imaging system 230. The imaging system 230 may include a high-resolution imager (e.g., CCD camera) or other type of detection device (e.g., PMT) for monitoring the ions while they are being provided to the trap 270 and/or after they have been provided to the trap 270 (e.g., to read results). In an aspect, the imaging system 230 can be implemented separate from the optical and trap controller 220, however, the use of fluorescence to detect, identify, and label ions using image processing algorithms may need to be coordinated with the optical and trap controller 220.

In addition to the components described above, the QIP system 200 can include a source 260 that provides atomic species (e.g., a plume or flux of neutral atoms) to the chamber 250 having the trap 270. When atomic ions are the basis of the quantum operations, that trap 270 confines the atomic species once ionized (e.g., photoionized). The trap 270 may be part of what may be referred to as a processor or processing portion of the QIP system 200. That is, the trap 270 may be considered at the core of the processing operations of the QIP system 200 since it holds the atomic-based qubits that are used to perform or implement the quantum operations or simulations. At least a portion of the source 260 may be implemented separate from the chamber 250.

It is to be understood that the various components of the QIP system 200 described in FIG. 2 are described at a high-level for ease of understanding. Such components may include one or more sub-components, the details of which may be provided below as needed to better understand certain aspects of this disclosure.

Aspects of this disclosure may be implemented at least partially using the QIP system 200 with the optical elements of a beam shaping structure as arranged therein.

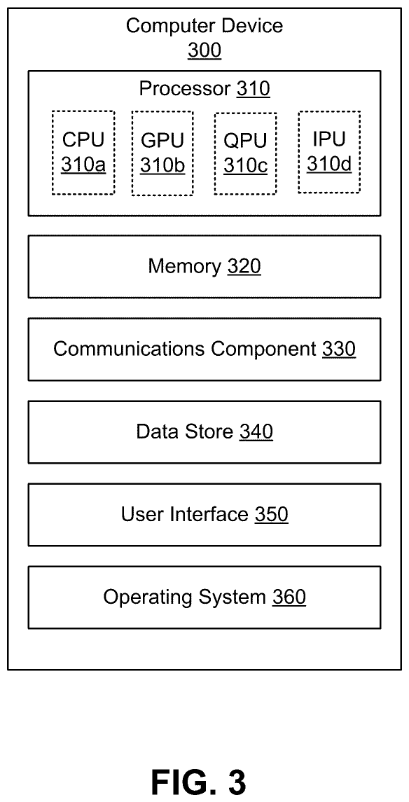

Referring now to FIG. 3, an example of a computer system or device 300 is shown. The computer device 300 may represent a single computing device, multiple computing devices, or a distributed computing system, for example. The computer device 300 may be configured as a quantum computer (e.g., a QIP system), a classical computer, or to perform a combination of quantum and classical computing functions, sometimes referred to as hybrid functions or operations. For example, the computer device 300 may be used to process information using quantum algorithms, classical computer data processing operations, or a combination of both. In some instances, results from one set of operations (e.g., quantum algorithms) are shared with another set of operations (e.g., classical computer data processing). A generic example of the computer device 300 implemented as a QIP system capable of performing quantum computations and simulations is, for example, the QIP system 200 shown in FIG. 2.

The computer device 300 may include a processor 310 for carrying out processing functions associated with one or more of the features described herein. The processor 310 may include a single processor, multiple set of processors, or one or more multi-core processors. Moreover, the processor 310 may be implemented as an integrated processing system and/or a distributed processing system. The processor 310 may include one or more central processing units (CPUs) 310a, one or more graphics processing units (GPUs) 310b, one or more quantum processing units (QPUs) 310c, one or more intelligence processing units (IPUs) 310d (e.g., artificial intelligence or AI processors), or a combination of some or all those types of processors. In one aspect, the processor 310 may refer to a general processor of the computer device 300, which may also include additional processors 310 to perform more specific functions (e.g., including functions to control the operation of the computer device 300). Quantum operations may be performed by the QPUs 310c. Some or all of the QPUs 310c may use atomic-based qubits, however, it is possible that different QPUs are based on different qubit technologies.

The computer device 300 may include a memory 320 for storing instructions executable by the processor 310 to carry out operations. The memory 320 may also store data for processing by the processor 310 and/or data resulting from processing by the processor 310. In an implementation, for example, the memory 320 may correspond to a computer-readable storage medium that stores code or instructions to perform one or more functions or operations. Just like the processor 310, the memory 320 may refer to a general memory of the computer device 300, which may also include additional memories 320 to store instructions and/or data for more specific functions.

It is to be understood that the processor 310 and the memory 320 may be used in connection with different operations including but not limited to computations, calculations, simulations, controls, calibrations, system management, and other operations of the computer device 300, including any methods or processes described herein.

Further, the computer device 300 may include a communications component 330 that provides for establishing and maintaining communications with one or more parties utilizing hardware, software, and services. The communications component 330 may also be used to carry communications between components on the computer device 300, as well as between the computer device 300 and external devices, such as devices located across a communications network and/or devices serially or locally connected to computer device 300. For example, the communications component 330 may include one or more buses, and may further include transmit chain components and receive chain components associated with a transmitter and receiver, respectively, operable for interfacing with external devices. The communications component 330 may be used to receive updated information for the operation or functionality of the computer device 300.

Additionally, the computer device 300 may include a data store 340, which can be any suitable combination of hardware and/or software, which provides for mass storage of information, databases, and programs employed in connection with the operation of the computer device 300 and/or any methods or processes described herein. For example, the data store 340 may be a data repository for operating system 360 (e.g., classical OS, or quantum OS, or both). In one implementation, the data store 340 may include the memory 320. In an implementation, the processor 310 may execute the operating system 360 and/or applications or programs, and the memory 320 or the data store 340 may store them.

The computer device 300 may also include a user interface component 350 configured to receive inputs from a user of the computer device 300 and further configured to generate outputs for presentation to the user or to provide to a different system (directly or indirectly). The user interface component 350 may include one or more input devices, including but not limited to a keyboard, a number pad, a mouse, a touch-sensitive display, a digitizer, a navigation key, a function key, a microphone, a voice recognition component, any other mechanism capable of receiving an input from a user, or any combination thereof. Further, the user interface component 350 may include one or more output devices, including but not limited to a display, a speaker, a haptic feedback mechanism, a printer, any other mechanism capable of presenting an output to a user, or any combination thereof. In an implementation, the user interface component 350 may transmit and/or receive messages corresponding to the operation of the operating system 360. When the computer device 300 is implemented as part of a cloud-based infrastructure solution, the user interface component 350 may be used to allow a user of the cloud-based infrastructure solution to remotely interact with the computer device 300.

In connection with the systems described in FIGS. 1-3, in one or more implementations, the QIP systems as disclosed herein include structures inserted into the QIP system that improve the efficiency of trapping ions relative to conventional trapping structures.

Quantum computers are expected to contribute more efficient and accurate ways of modeling economic processes than traditional computers. Quantum hardware is currently available at a relatively small scale, but effective algorithms are limited by the number of logic gates that can be used, before noise from gate inaccuracies tends to dominate results. Some theoretical algorithms that have been proposed and studied for years do not perform well yet on quantum hardware in practice. This encourages the development of suitable alternative algorithms that play similar roles in limited contexts.

The present disclosure implements this strategy in the case of quantum counting, which is used as a component for keeping track of position in a quantum walk, which is used as a model that, for example, simulates asset prices over time. The present disclosure introduces quantum approximate counting circuits that use far fewer 2-qubit entangling gates than traditional quantum counting, which relies on binary positional encoding. The robustness of these circuits to noise is demonstrated.

In mathematical terms, the key features that distinguish quantum from classical computers are superposition and entanglement. A brief summary of how these properties are worked within quantum circuits is now presented. |0 [symbol] and |1 [symbol] are the basis states for a single qubit whose state is represented in the complex vector space C². A 2-qubit state is represented in the tensor product space C²⊗C²≅C⁴ with basis states |00 [symbol] , |01 [symbol] , |10 [symbol] and |11 [symbol] . 3-qubit states are represented in C^{⊗}^{₃}≅C⁸ with basis states |000 [symbol] , |001 [symbol] , . . . , |111 [symbol] , and so on.

Quantum measurement is probabilistic: if |φ [symbol] is an eigenvector of a given measurement operator, then a system in the state |ψ [symbol] is observed to be in the state |φ [symbol] with probability given by the square of their scalar product, [symbol] φ|ψ [symbol] ² (the Born rule), and if this outcome is observed, the system is now in the state |φ [symbol] . Superposition can be realized in a single qubit: the state α|0 [symbol] +β|1 [symbol] is a superposition of the states |0 [symbol] and |1 [symbol] , where α and β are complex numbers, with |α²|+|β²|=1. Each single-qubit logic is a linear operator that preserves the orthogonality of the basis states and this normalization condition, and the group of such operators is U(2), the group of complex 2×2 unitary matrices. Single-qubit gates coherently manipulate the superposition state of an individual qubit.

Entanglement is a property that connects different qubits. All modern quantum computers have some implementation of an entangling gate. The CNOT (controlled-NOT) gate is the most common example of a 2-qubit gate. In the standard basis, a CNOT gate performs a NOT operation on the target qubit if the control qubit is in the |1 [symbol] state.

Entanglement is a property that distinguishes quantum computing algorithmically, because predicting the probability distributions that result from quantum operations with entanglement can become exponentially hard for classical computers. In simpler terms, quantum computing is special because it offers special kinds of interference, not because it offers special kinds of in-between-ness.

Quantum circuits finish with measurements that record the 0 or 1 state of at least some of the qubits, and output this as classical information. (Some platforms also support measuring qubits before the end of a circuit.) The measurement outcomes are probabilistic, following the Born rule. A run of a single quantum circuit including outputting one sample of measurements is typically called a shot. Circuits are usually repeated several times, and the output counts from many individual shots are summarized into an output distribution. The process of running all the shots and gathering the outcomes is typically called a job.

A random walk is a mathematical process that constructs a path through some base space composed of a succession of randomly-chosen steps. Random walks have been used to model a range of scenarios including physical (Brownian) motion, population dynamics, and web browsing sessions, though they were first proposed for modeling prices of stocks. A classical random walk with unit steps up-or-down leads to a binomial distribution, which at large scales is approximated by a corresponding normal distribution. Thus, for large simulations, the simplifying assumption of a fixed size for each step is immaterial, because the overall distribution is normal.

Quantum random walks are a counterpart for classical random walks. In economics, quantum walks have been proposed as an alternative that takes into account key factors including varying beliefs or opinions about the future, and the transactions between different traders. Another anticipated benefit of these quantum walk models is that such models work natively on quantum computers, when large fault-tolerant quantum hardware is available. Quantum walks are thus expected to be a powerful component in pricing models. Often the term “quantum walk” is preferred to the term “quantum random walk,” not only for brevity, but because the internal state of a quantum walk is typically an entirely deterministic superposition of different states. For example, a walk that starts in position 0 with a 50-50 chance of going in either direction will, after one step, be in a superposition of the states representing positions −1 and +1, with equal amplitudes in the superposition. The quantum state vector representing this superposition can be predicted exactly; it is only the measurement outcome that is probabilistic when one of these distinct possibilities is randomly selected.

A quantum walk includes a quantum walker and quantum coin. At each turn, the coin is tossed, and the position of the walker moves depending on the resulting state of the coin. A canonical example is an unrestricted discrete walk, where the positions correspond to integers, and each move is a single step, represented by incrementing the position integer by ±1.

To simulate a quantum walk, a coin toss is modelled with tracking position. A single qubit and a Hadamard gate may be used, which act like a “beam-splitter,” putting the coin into a superposition of |0 [symbol] and |1 [symbol] states.

The challenge for quantum computers is tracking the position (i.e., the quantum counting problem). For non-negative numbers, the states |n [symbol] may be associated with the energy levels in a harmonic oscillator. In theory this may connect the process of quantum counting with the use of motional modes in for quantum information processing, but this is not yet available on commercial quantum computers.

Numbers of computers may be represented in binary positional notation. For example, the binary expression 110 represents the number 6 (or the number 3, if the bits are read in reverse order). Choosing a binary positional encoding, as used in classical computing, makes quantum counting very susceptible to 2-qubit gate errors, because manipulating binary encodings takes a lot of entanglement and coordination between qubits. To compute the sum of two binary numbers A and B of bitlength n using classical Boolean algebra, the least significant bits are added (XOR), and then at each other position the corresponding bits along with a “carry” from the previous stage are added, setting the output and passing a “carry” on to the next position. If it takes 11 2-qubit gates for each full-adder, then adding two single-byte (8-bit) numbers using this approach uses ~80 2-qubit gates. Thus, by the time such a register has successively added 10 numbers, the chances of an error are over 50% even with a two-qubit gate fidelity of 99.9%, which is on the high-end of performance estimates at the time of writing. The ongoing presence of errors in NISQ-era machines for conventional quantum binary “adder circuits” limits the number of steps that can be reliably counted.

Error rates with quantum counting can thus undermine the simulation of quantum walks, and block this application of quantum finance. It should be noted that some noise or decoherence can be useful in quantum models, for example, in deriving price estimates from many quantum walk simulations. The predictions later in this present disclosure are also averages over many somewhat-noisy circuits. A technical challenge here is to understand the noisy behaviors, and find those that work well enough to enable the task at hand.

The central modeling problem of the present disclosure involves modelling a quantum walk on a quantum computer. It should be noted, however, that using positional binary notation to represent integer quantities requires “increment” and “decrement” operators that require too many entangling gates to give accurate results on current quantum hardware.

To avoid these pitfalls, the present disclosure describes alternative circuit designs that can also be used for recording position in a random walk. Instead of trying to ensure that every move goes up and down by exactly one step on the position axis, the position register is incremented using some gate combination that is likely to move the position by some amount that is generally positive for upward steps, and downwards for downward steps. Another way to describe this is that instead of putting all the randomness in the coin toss and following this with deterministic shift operators, a random coin is tossed and combined with a somewhat-random shift operator. For larger circuits, such methods can give a walk that goes up and down more reliably than the results received if it is insisted that the position represented by the state |n [symbol] is an accumulation of exactly n steps of unit length in that direction.

All results from the circuits described in the present disclosure are naturally noisy. Some of the randomness is purely quantum, in that different runs of the same circuit are expected to give different measurements according to the Born rule, and running jobs with more shots gives closer statistical approximations to the “real” quantum distribution. For some of the design patterns, randomness is also due to the way the circuits are constructed, so this randomness is expected and is classical in nature. Also, NISQ-era results also include noise from hardware errors. It is not always immediately obvious which sources of noise or randomness are most impactful for a given design, though some of the key features are noted.

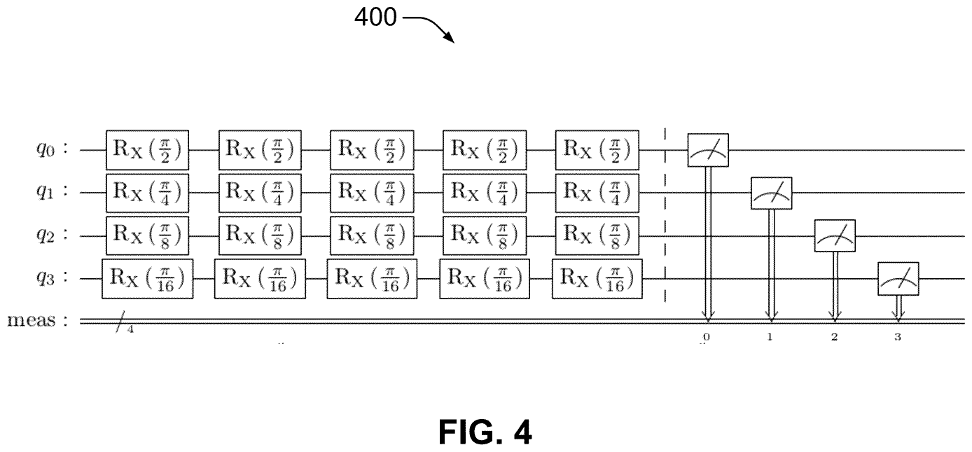

FIG. 4 illustrates an example 400 of an arc counter circuit. This circuit design uses only single-qubit rotations throughout its structure. These are used as base units for addition. Each qubit is used to represent one digit in a binary register, and each bit is twice as significant as its predecessor. At each step, each qubit is rotated through an angle that is inversely proportional to that qubit's significance. This means that the n+1^{th} qubit rotates at half the rate of the n^{th} qubit. Random variations in the outputs are expected, because many fractional angles are used throughout the circuit. Since there are no 2-qubit entangling gates, error rates are lower.

As shown in example 400, the circuit includes four qubits. The first qubit is rotated five times by rotation gates along the x-axis, each by an angle of π/2 radians. The second qubit is rotated five times, each by an angle of π/4 radians. The third qubit is rotated fives times, each by an angle of π/8 radians. The fourth qubit is rotated five times, each by an angle of π/16 radians.

An analogy for this representation is to consider each qubit as one of the hands on a traditional analog clock. On an analog clock, the minute hand cycles at 12 times the speed of the hour hand, and the second hand 60 times faster still, whereas in a binary clock, the ratio between the speed of rotation of each successive pair of “hands” is 2:1. This analogy works well for the standard binary positional notation for integers, which can be thought of as a binary digital clock. In a digital register (or an abacus), the digits logically depend on one another for correct incrementing, because one needs to know that one register is full before the next is incremented. By contrast, the hour hand on a clock does not “carry” information when the minute hand completes a cycle—it just rotates at its own slower pace. Thus the rotation encoding clock-based design requires much less coordination (and hence entanglement) between the qubits.

This comes at a representational cost—the register does not represent exact integers, and random variations in the outputs are expected, because many fractional angles are used throughout the circuit. This is true for the basic counting operation, irrespective of whether the counting is coupled with a “coin toss” operation.

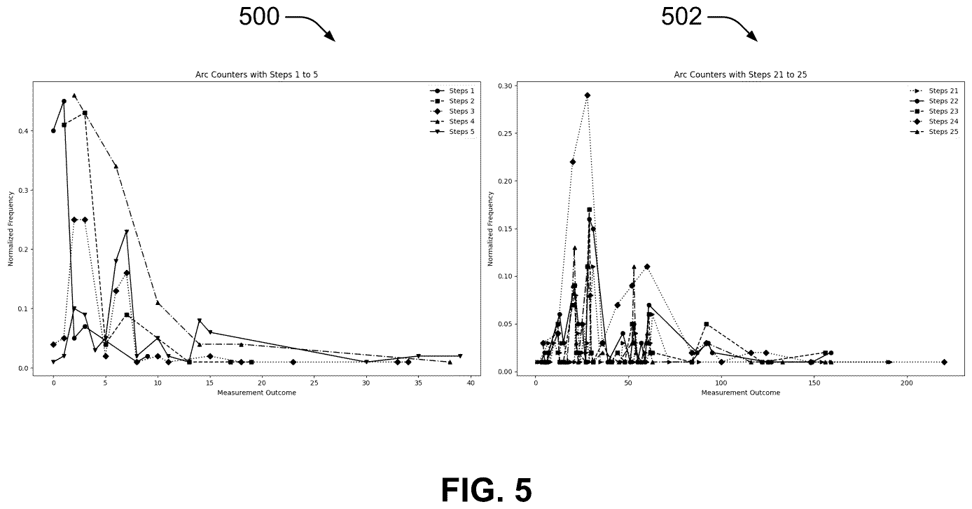

FIG. 5 illustrates sample results 500 and 502 from a quantum walk with an 8 qubit register. Statistically noteworthy properties include:
(1) The mean distance from the starting point generally increases with the number of steps.
(2) In some cases, the position appears to jump ahead, because a high-order qubit is measured in the |1 [symbol] state.
(3) This can happen (with low probability) after just a single step.
(4) There are sometimes peaks in the distributions after specific powers of two or their combinations (e.g., peaks at 48, 64, 96).
(5) It may be possible and desirable to find ways to smooth out these peaks.

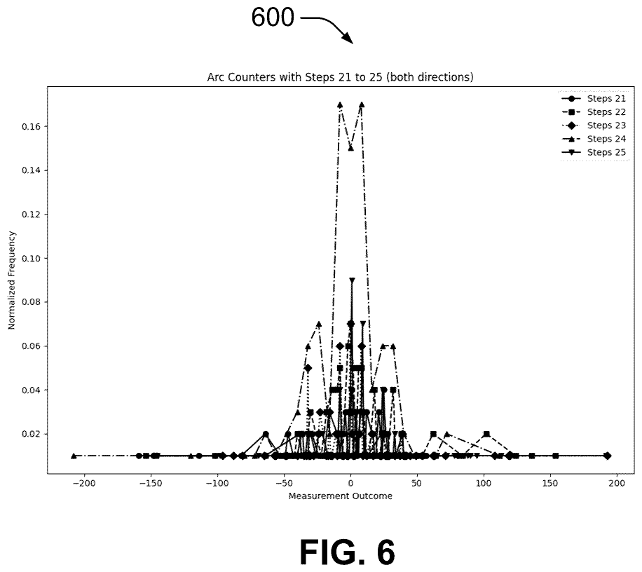

An alternative method for simulating random walks that can evolve in both directions is to use two quantum circuits: one for the “up” steps and one for the “down” steps, and subtract the results from the down circuit from the results from the “up” circuit as a classical post-processing step. In some aspects, the “up” and “down” circuits are configured with different “clock speeds,” for which the results are shown in FIG. 6 in graph 600. The results shown dissipate outwards from the starting point, in both directions. In some cases the up and down contributions cancel out, leaving the walker near the starting point, but in some cases, one direction predominates.

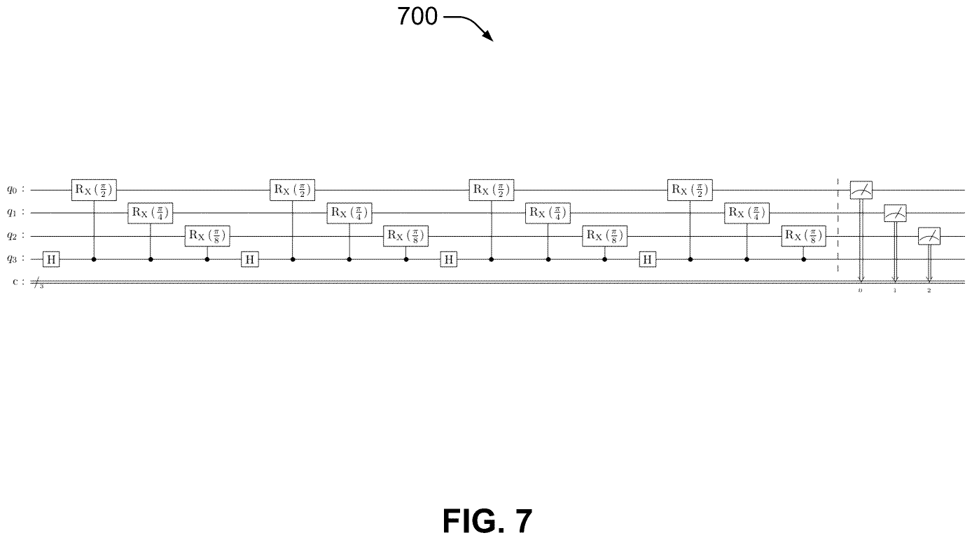

FIG. 7 illustrates an example 700 of an arc walk counter circuit. This circuit design combines the arc rotations of the arc counter design in FIG. 4, with the “Hadamard quantum coin.” At each step, a Hadamard gate “tosses a coin,” and if the outcome is “heads”, or |1 [symbol] , a controlled rotation is performed on each of the other qubits, following the same pattern of angles as in the arc counter circuit in FIG. 4. This gives the circuit pattern of example 700. If the result is not |1 [symbol] , the circuit skips all of the rotations to be performed on q0, q1, and q2.

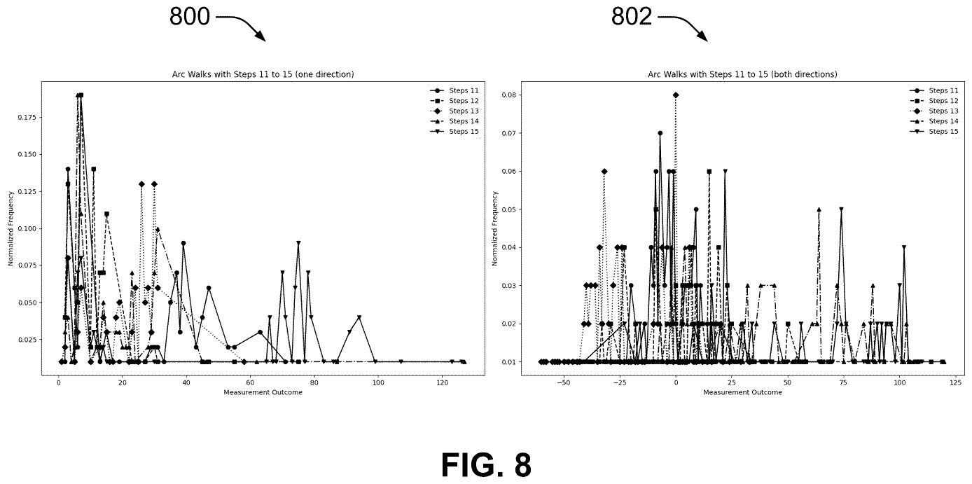

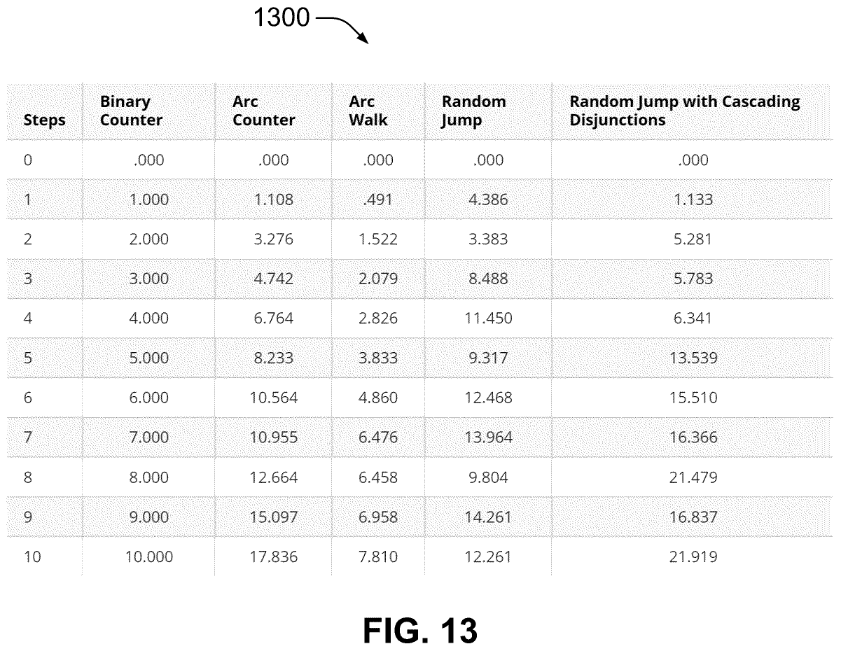

FIG. 8 illustrates example results 800 for the arc walk counter circuit (with 8 counter qubits, 10 to 15 steps). Results 800 are for purely incrementing circuit and results 802 is a two-way walk using the reversal and superposition technique described above. The results appear similar to those of FIG. 5, though the table of average results in FIG. 13 suggests that the average position reached can plateau sooner.

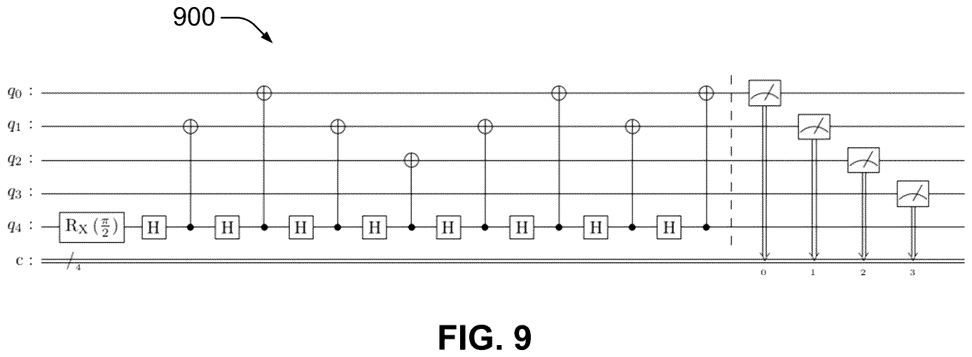

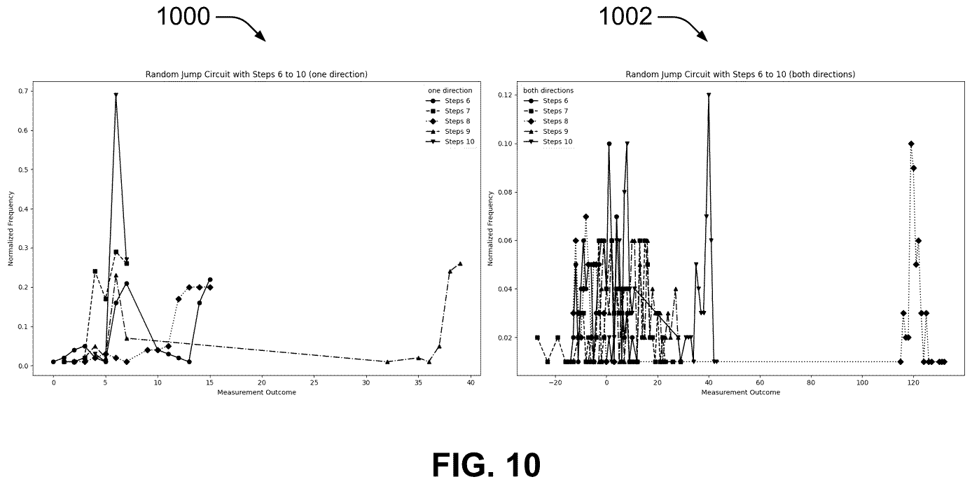

FIG. 9 illustrates an example 900 of a random jump circuit. In this class of examples, instead of using smaller rotations for higher-order qubits, the circuit is set up so that these qubits are changed less often. This can be done with and without a quantum coin controlling the gates. Example 900 uses a standard Hadamard quantum coin. At each step, a different target qubit in the counter register is selected, according to some weighted random sampling function(e.g., f(n)=1/2ⁿ, starting with n=1). This function should prefer the lower-order qubits. In the sample results shown in FIG. 10, the selection was done with the distribution {½, ¼, ⅛, etc.} . Note that the circuit creation now introduces classical randomness, as well as the circuit measurement still having quantum randomness.

FIG. 10 specifically shows results for up to 9 steps, using an 8 qubit counter register. Example 1000 shows positive only while example 1002 shows two-way walk using reversal and superposition. As expected, each walk can go both ways (because randomly flipping a bit can reduce as well as increase a number), though the average tendency for an individual walk is to increase. This is because the registers are initialized to zero, so the process randomly diffuses out from zero. The results trend in similar fashions to the results in FIGS. 5 and 8, but they are more pointed or extreme in some cases—partly because a random choice to include a large jump can be made classically, and then applied to all shots, rather than quantum randomness which varies between shots.

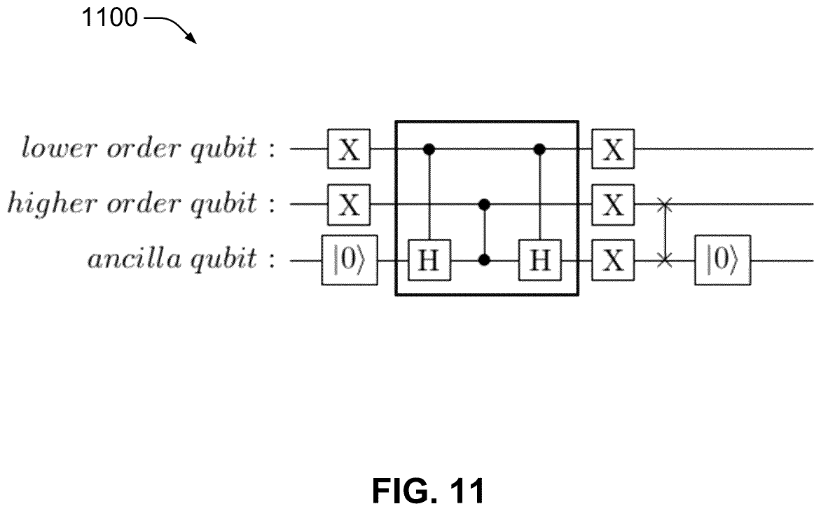

FIG. 11 illustrates an example 1100 of a cascading disjunction circuit. Example 1100 is an extra circuit component that can be added to any of the counting circuits above. The idea uses a standard circuit component that performs Boolean disjunction. The portion within the rectangle is the structure for a logical conjunction AND operator.

The portion changes the ancilla qubit from |0 [symbol] to |1 [symbol] if and only if both the lower and higher order qubits are in the |1 [symbol] position. The X gates surrounding this portion implement the standard NOT operations to turn an AND conjunction operator into an OR disjunction operator (A OR B=NOT(NOT A AND NOT B)). Finally, the swap gate and the reset to |0 [symbol] operations ensure that the output is written back into the higher order qubit, and the ancilla qubit is reset to its initial state. It should be noted that using this construction several times may require a mid-circuit reset.

In this implementation, such gates are added between randomly chosen lower- and higher-order bits, using the same sampling distribution as in the random jump circuits. This enables the values of lower-order qubits to propagate to higher-order qubits, which increases and tends to preserve progress in the walk, because the higher-order qubits are less likely to be randomly selected to be switched back to |0 [symbol] later.

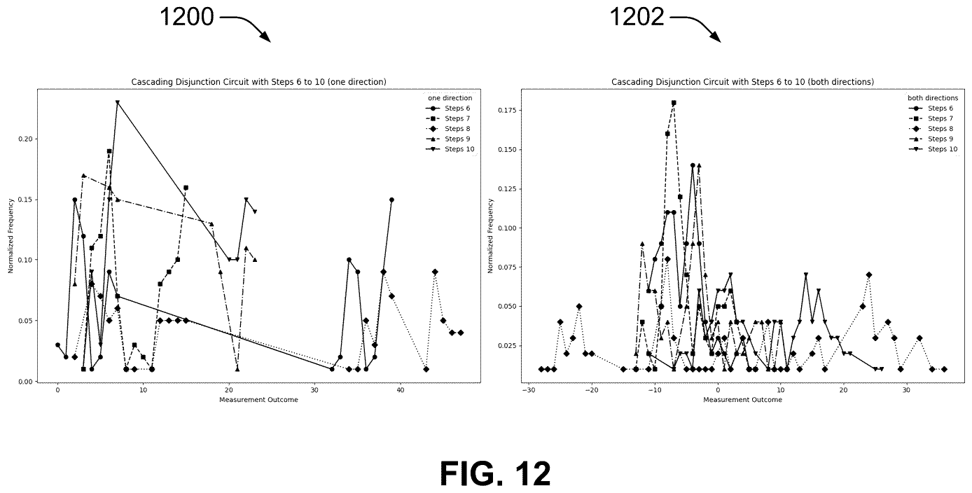

FIG. 12 illustrates sample results when implementing a cascading disjunction circuit. Example 1200 shows positive only and example 1202 shows a two-way walk using reversal and superposition. The walks are still random, but propagating more reliably with the cascading disjunction components. The results show large randomness similar to those in results 1000 and 1002, but none of the walkers appear to be “left behind,” perhaps due to the cascading disjunctions.

Another variant of this technique is to add a conjunction between the coin qubit and the target qubit, that sets the next higher qubit to |1 [symbol] before reversing the target qubit to |0 [symbol] . This would behave like a limited-carry operation: it performs some of the coordination between qubit values in the traditional bit-counter circuits in the literature, but much less, in a much more targeted fashion.

The circuits examples shown in FIGS. 4, 7, 9, and 11 may be executed by computer device 300. In particular, an advantage for the circuit models in the present disclosure is that they can be run much more easily on NISQ-era quantum hardware.

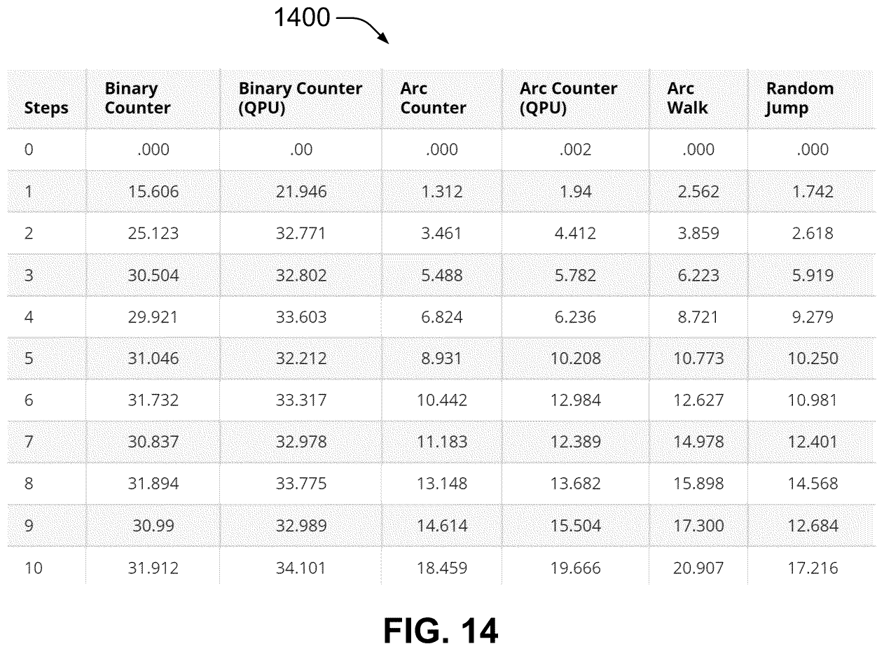

Preliminary results for the different circuit designs presented in the present disclosure are given in FIGS. 13 and 14. FIG. 13 illustrates table 1300 of average distances traveled after n steps in an ideal simulation. FIG. 14 illustrates table 1400 of average distances traveled after n steps in a noisy simulation.

The goal of the presented circuits is the reliable representation and incrementing of position such that the key comparison is with a binary counter itself, rather than the use of a binary counter going up and down in a random walk. The new circuits are evaluated with n positive steps, without subtracting the results of a walk in the other direction. The use of cascading disjunctions is included in the ideal “random jump” circuit, though not in the noisy simulation. The simulations use 6-qubit counting registers and represent numbers from 0 to 63. In addition, the binary counter and arc counter circuits were run on a quantum computer with 11 trapped-ion qubits. These results are also shown in FIG. 14, with the label QPU.

The random jump results were computed using 30 shots on each of 30 randomly-generated circuits, so these results include both classical and quantum randomness. The binary and arc circuits are generated deterministically, so these results include 1000 shots for a single circuit, and all the randomness is quantum.

As shown in tables 1300 and 1400, the binary counter results are perfect with ideal simulation, but are rendered ineffective in the noisy simulation. In the noisy simulation, the binary counter results quickly converge to a random number 31.912, which is the average. For all the other circuits, the difference between the ideal results and the noisy results is much less. The average results for the arc counter and arc walk circuits are the most reliable for simulating a monotonically-increasing position, with or without noise. The random jump results also tend to increase, but tend to plateau and then move up and down randomly (this randomness is smaller with a larger register).

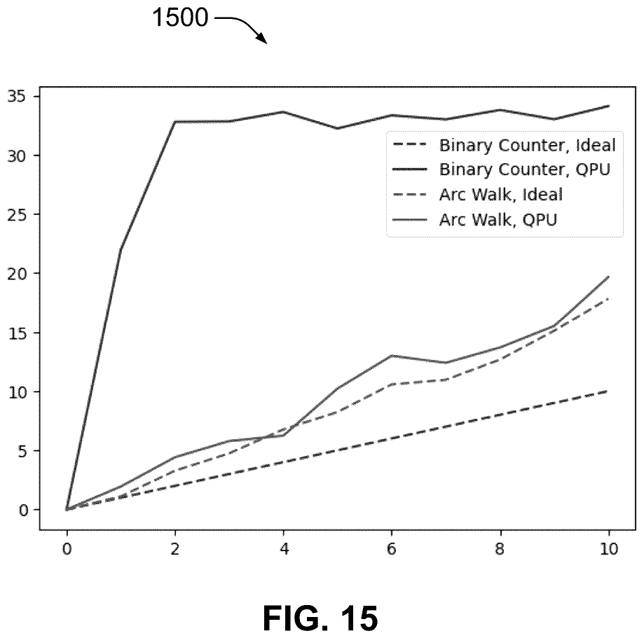

FIG. 15 illustrates graph 1500 comparing ideal and actual QPU results for binary counter and arc walk circuits. Graph 1500 shows how quickly the binary counter becomes ineffective on a real QPU, whereas by contrast, the arc counter QPU results stay close to the ideal simulated results. More specifically, the QPU result is much closer to the ideal monotonically-increasing results for the arc counter, whereas the QPU result of the binary counter indicates that the binary counter is unusable after 2 steps.

The previous description of the disclosure is provided to enable a person skilled in the art to make or use the disclosure. Various modifications to the disclosure will be readily apparent to those skilled in the art, and the common principles defined herein may be applied to other variations without departing from the scope of the disclosure. Furthermore, although elements of the described aspects may be described or claimed in the singular, the plural is contemplated unless limitation to the singular is explicitly stated. Additionally, all or a portion of any aspect may be utilized with all or a portion of any other aspect, unless stated otherwise. Thus, the disclosure is not to be limited to the examples and designs described herein but is to be accorded the widest scope consistent with the principles and novel features disclosed herein.

1. A method for performing a quantum walk, comprising:
generating a counter circuit that implements solely single-qubit rotations, wherein each respective qubit of a plurality of qubits in the arc counter circuit is rotated through an angle that is inversely proportional to a significance of the respective qubit and wherein the respective qubit is twice as significant as a predecessor qubit; and
executing the counter circuit using a quantum processor unit (QPU).

2. The method of claim 1, wherein each qubit of the plurality of qubits represents a digit in a binary register.

3. The method of claim 1, wherein the counter circuit comprises four qubits in the plurality of qubits.

4. The method of claim 3, wherein each of the four qubits is rotated by five rotation gates.

5. The method of claim 4, wherein a rotation gate associated with a first qubit performs a rotation along an x-axis by π/2 radians, a rotation gate associated with a second qubit performs a rotation along an x-axis by π/4 radians, a rotation gate associated with a third qubit performs a rotation along an x-axis by π/8 radians, a rotation gate associated with a fourth qubit performs a rotation along an x-axis by π/16 radians.

6. The method of claim 1, wherein the arc counter circuit further includes a plurality of Hadamard gates, wherein at each step, a Hadamard gate of the plurality of Hadamard gates is used to determine whether a controlled rotation is performed on each other qubit of the plurality of qubits.

7. The method of claim 6, wherein the controlled rotation is performed when the Hadamard gate outputs |1 [symbol] .

8. The method of claim 1, wherein the counter circuit further comprises a circuit component that performs Boolean disjunction.

9. The method of claim 8, wherein the circuit component includes a logical conjunction AND operator that changes a state of an ancilla qubit of the counter circuit |0 [symbol] to |1 [symbol] only when all lower and higher order qubits have state |1 [symbol] .

10. A quantum information processing (QIP) system comprising:
at least one memory; and
at least one hardware processor coupled with the at least one memory and configured, individually or in combination, to:
generate a counter circuit that implements solely single-qubit rotations, wherein each respective qubit of a plurality of qubits in the arc counter circuit is rotated through an angle that is inversely proportional to a significance of the respective qubit and wherein the respective qubit is twice as significant as a predecessor qubit; and
execute the counter circuit.

11. The QIP system of claim 10, wherein each qubit of the plurality of qubits represents a digit in a binary register.

12. The QIP system of claim 10, wherein the counter circuit comprises four qubits in the plurality of qubits.

13. The QIP system of claim 12, wherein each of the four qubits is rotated by five rotation gates.

14. The QIP system of claim 13, wherein a rotation gate associated with a first qubit performs a rotation along an x-axis by π/2 radians, a rotation gate associated with a second qubit performs a rotation along an x-axis by π/4 radians, a rotation gate associated with a third qubit performs a rotation along an x-axis by π/8 radians, a rotation gate associated with a fourth qubit performs a rotation along an x-axis by π/16 radians.

15. The QIP system of claim 10, wherein the arc counter circuit further includes a plurality of Hadamard gates, wherein at each step, a Hadamard gate of the plurality of Hadamard gates is used to determine whether a controlled rotation is performed on each other qubit of the plurality of qubits.

16. The QIP system of claim 15, wherein the controlled rotation is performed when the Hadamard gate outputs |1 [symbol] .

17. The QIP system of claim 10, wherein the counter circuit further comprises a circuit component that performs Boolean disjunction.

18. The QIP system of claim 17, wherein the circuit component includes a logical conjunction AND operator that changes a state of an ancilla qubit of the counter circuit |0 [symbol] to |1 [symbol] only when all lower and higher order qubits have state |1 [symbol] .
